(19) United States
(12) Patent Application Publication
(10) Pub. No.: US 2020/0282377 A1
(43) Pub. Date: Sep. 10, 2020

(54) GRANULAR ACTIVATED CARBON AND METHOD FOR MANUFACTURING SAME

(71) Applicant: LIXIL Corporation, Tokyo (JP)

(72) Inventors: Kazuhiro SATO, Tokyo (JP); Masanari TOYAMA, Tokyo (JP); Hirohito NAKAJIMA, Tokyo (JP); Takeyuki YAMAMOTO, Tokyo (JP); Takahisa ISHIKAWA, Tokyo (JP); Hiroki MAENAMI, Tokyo (JP); Naoya TAMURA, Tokyo (JP); Hajime OTA, Tokyo (JP)

(73) Assignee: LIXIL Corporation, Tokyo (JP)

(21) Appl. No.: 16/648,652

(22) PCT Filed: Aug. 6, 2018
(86) PCT No.: PCT/JP2018/029454

§ 371 Date: Mar. 18, 2020

(30) Foreign Application Priority Data
Sep. 29, 2017 (JP) 2017-192124

(51) Int. Cl. B01J 20/20; B01J 20/28; B01J 20/30; C01B 32/384; C02F 1/28

(52) U.S. Cl. CPC B01J 20/20; B01J 20/2803; B01J 20/28004; B01J 20/3042; C01P 2004/50; C01B 32/384; C02F 1/283; C01P 2004/03; B01J 20/3028

(57) ABSTRACT

Provided is a granular activated carbon which has a filtered flow rate of a predetermined value or higher, and a high water purification performance; and a method for manufacturing the same. A granular activated carbon comprises a plurality of activated carbon granules and a binder for binding the plurality of activated carbon granules, wherein the binder is composed of net-like fibers. Also, a method for manufacturing the granular activated carbon includes a step for spraying and drying slurry which is obtained by dispersing the activated carbon granules and the fibers in water.

### CROSS-REFERENCE TO RELATED APPLICATIONS

This application is a national stage application under 35 USC 371 of International Application No. PCT/JP2018/029454, filed Aug. 6, 2018, which claims the priority of Japanese Application No. 2017-192124, filed Sep. 29, 2017, the entire contents of each of which are incorporated herein by reference.

### FIELD OF THE DISCLOSURE

The present invention relates to granular activated carbon and a method for manufacturing the same. More specifically, embodiments of the present invention relate to granular activated carbon for purifying water and a method for manufacturing the same.

### BACKGROUND OF THE DISCLOSURE

In the related art, tap water purified by a water filter is used as drinking water or cooking water. In general, an activated carbon or a molded body of activated carbon granules is used as a filtering medium by being incorporated in the water filter, along with a filtration filter or the like. For example, a water filter in which a molded body of activated carbon granules such as a coconut activated carbon powder is incorporated has been proposed (for example, refer to Patent Document 1).

Here, FIG. 6 is a schematic view illustrating a relationship between a water purification performance and a filtered flow rate of a water filter using an activated carbon of the related art. As illustrated in FIG. 6, in the use of the water filter, the filtered flow rate that a user does not feel inconvenience is approximately 2.5 L/min. For this reason, an average granule diameter of the activated carbon is set to approximately 80 μm, and thus, it is possible to increase the water purification performance while maintaining the filtered flow rate that the user does not feel inconvenience.

Patent Document 1: Japanese Unexamined Patent Application, Publication No. 2017-136589

### SUMMARY OF THE DISCLOSURE

However, a granular activated carbon has been considered to be used in order to easily handle the activated carbon. Even in a case where such a granular activated carbon is used, it is required to increase the water purification performance while maintaining the filtered flow rate that the user does not feel inconvenience.

Embodiments of the present invention have been made in consideration of the circumstances described above, and an object thereof is to provide a granular activated carbon which has a filtered flow rate of a predetermined value or more and a high water purification performance, and a method for manufacturing the same.

Embodiments of the present invention relates to a granular activated carbon, containing: a plurality of granule-shaped activated carbons; and a binder for binding the plurality of granule-shaped activated carbons, in which the binder is composed of net-like fibers.

In addition, it is preferable that the fibers be bound by being entangled with the granule-shaped activated carbons on a surface of the granular activated carbon and inside the granular activated carbon.

In addition, it is preferable that the fibers be contained in the granular activated carbon by 1 volume % to 5 volume %.

In addition, it is preferable that the fibers be fibril fibers.

In addition, it is preferable that the fibers be nanofibers.

In addition, it is preferable that a central granule diameter of the granule-shaped activated carbons be 40 μm or less.

In addition, embodiments of the present invention relate to a method for manufacturing the granular activated carbon described above, the method including: a step for spraying and drying slurry which is obtained by dispersing the granule-shaped activated carbons and the fibers in water.

According to embodiments of the present invention, it is possible to provide a granular activated carbon which has a filtered flow rate of a predetermined value or more and a high water purification performance, and a method for manufacturing the same.

### BRIEF DESCRIPTION OF THE FIGURES

FIG. 1 is an enlarged schematic view of a sectional surface in the vicinity of a surface of granule-shaped activated carbons of the related art, according to some embodiments;

FIG. 2 is an enlarged schematic view of a sectional surface in the vicinity of a surface of granule-shaped activated carbons, according to some embodiments;

FIG. 3 is an SEM image of the granule-shaped activated carbons of the related art;

FIG. 4 is an SEM image of the granule-shaped activated carbons, according to some embodiments;

FIG. 5 is an SEM image of the granule-shaped activated carbons, according to some embodiments; and

FIG. 6 is a schematic view illustrating a relationship between a water purification performance and a filtered flow rate of a water filter using an activated carbon, according to some embodiments.

### DETAILED DESCRIPTION OF THE DISCLOSURE

The present invention is not limited to the following embodiments.

A granular activated carbon according to some embodiments, for example, is used in a water purification cartridge in a water purification device that purifies water to be treated such as tap water. Such a granular activated carbon removes a removal target contained in the water to be treated by oxidation decomposition or adsorption. Examples of the removal target include an odor substance such as free residual chlorine contained in tap water, an organic compound such as trihalomethane, and the like.

### Granular Activated Carbon

The granular activated carbon according to some embodiments, contains: a plurality of granule-shaped activated carbons; and a binder for binding the plurality of granule-shaped activated carbons, in which the binder is composed of net-like fibers. Furthermore, herein, the “net-like fibers” indicate fibers in which a gap allowing a water flow is formed between fibers.

An activated carbon that is obtained from an arbitrary starting material can be used as the granule-shaped activated carbons. Specifically, an activated carbon obtained by carbonizing a coconut, a coal, a phenolic resin, and the like at a high temperature, and then, by performing activation can be used. The activation is a reaction that develops micropores of a carbonaceous material to be a porous material, and is performed by gas such as carbon dioxide and water vapor, drugs, or the like. Most of such granule-shaped activated carbons are formed of carbons, and a part thereof is formed of a compound of carbons and oxygen or hydrogen.

It is preferable that a central granule diameter D1 of the granule-shaped activated carbons in this embodiment be 40 μm or less. By setting the central granule diameter of the granule-shaped activated carbons to be within the range described above, an adsorbed amount of the removal target per unit mass of the granular activated carbon containing the granule-shaped activated carbons is improved. This is because a specific surface area of the granular activated carbon containing the granule-shaped activated carbons increases as the central granule diameter of the granule-shaped activated carbons decreases. The central granule diameter D1 is preferably 15 μm or less, and is more preferably 10 μm or less, from the viewpoint described above. Furthermore, the central granule diameter D1 of the granule-shaped activated carbons may be greater than 40 μm, but it is difficult to densify the granule-shaped activated carbons, and to increase water flow resistance, and thus, the necessity of granulating an activated carbon is low. In addition, it is preferable that the central granule diameter of the granule-shaped activated carbons be small from the viewpoint of an adsorption rate of the removal target described below.

Furthermore, in some embodiments, the central granule diameter D1 of the granule-shaped activated carbons is a value that is measured by a laser diffraction method, and indicates a value (D50) of 50% diameter in volume-based cumulative fractions. D1, for example, is measured by Microtrac MT3300EXII (a laser diffraction and scattering type granule diameter distribution meter, manufactured by MicrotracBEL Corp.).

The granular activated carbon containing the granule-shaped activated carbons according to some embodiments has a high adsorption rate of the removal target. The water purification cartridge that is used in a water filter is required to have an extremely high adsorption rate. For example, the content of a general water purification cartridge is approximately 35 cc, and for example, in a case where tap water having a flow rate of 2500 cc/min permeates through the water purification cartridge, as the water to be treated, the total amount of water in the cartridge is replaced for approximately 0.8 seconds. Accordingly, in a case where the adsorption rate of the activated carbon is not sufficient, the removal target is not sufficiently removed in accordance with a flow rate of the water to be treated. Here, the granule-shaped activated carbons according to this embodiment have a granule diameter that is smaller than that of granule-shaped activated carbons of the related art. A relationship between the adsorption rate and the granule diameter of the activated carbon will be described below with reference to the drawings.

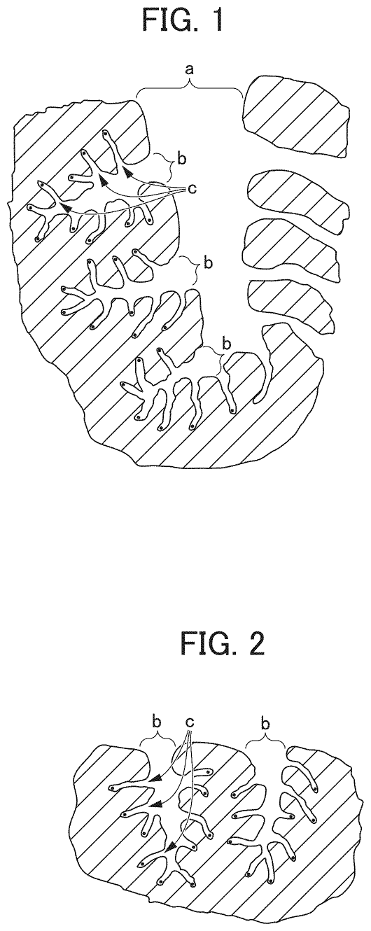

FIG. 1 is an enlarged schematic view of a sectional surface in the vicinity of the surface of granule-shaped activated carbons (a granule diameter of 80 μm) that are used in a water filter of the related art. In addition, similarly, FIG. 2 is an enlarged schematic view of a sectional surface in the vicinity of the surface of the granule-shaped activated carbons (a granule diameter of approximately 9 μm) according to some embodiments. In FIG. 1 and FIG. 2, is macropores having diameter of 50 nm or more, b is mesopores having a diameter of 2 nm to 50 nm, and c is micropores having a diameter of 2 nm or less. In addition, a black point portion represents a reaction site at which the removal target is adsorbed. Fine pores on the surface of the activated carbon adsorb a substance having a size that is coincident with the size of the pore, and as illustrated in FIG. 1 and FIG. 2, the reaction site mainly exists in the micropores c. This is because the removal target in a water treatment, for example, is mainly a substance of which a molecular weight is comparatively small, such as CHCl₃ as trihalomethane.

In FIG. 1, the removal target that infiltrates from the surface of the activated carbon, such as CHCl₃, reaches the reaction site through the macropores a, the mesopores b, the micropores c. In contrast, in FIG. 2, the removal target that infiltrates from the surface, such as CHCl₃, reaches the reaction site through the mesopores b and the micropores c, and thus, a distance to the reaction site is shorter than a distance in FIG. 1. Accordingly, the adsorption rate of the granule-shaped activated carbons according to some embodiments is higher than that of the granule-shaped activated carbons of the related art.

The granule-shaped activated carbons according to some embodiments of which the central granule diameter D1 is 40 μm or less, for example, is obtained by pulverizing the activated carbon that is formed of an arbitrary starting material as described above, with a known method using a ball mill, a disk mill, a jet mill, or the like, and by performing classification with a sieve, a cyclone classifier, or the like.

The net-like fibers according to some embodiments are bound by being entangled with the granule-shaped activated carbons on the surface of the granular activated carbon and inside the granular activated carbon. A gap allowing a water flow is formed on the surface of the granular activated carbon and inside the granular activated carbon, and thus, it is possible to increase a filtered flow rate and a water purification performance of the granular activated carbon.

In addition, the fibers include at least fibril fibers or nanofibers. The net-like fibers according to some embodiments, for example, are fine fibers referred to as microfibers or nanofibers, and form a granulated body by being entangled with the granule-shaped activated carbons. Examples of such microfibers or nanofibers include cellulose microfibers, cellulose nanofibers, and nanofibers obtained by refining synthetic resin fibers. The nanofibers of the synthetic resin fibers are obtained by a mechanical treatment such as a high-pressure homogenizer or a grinder method, an electrospinning method, and the like. Cellulose is known to be produced from trees or plants, some animals, fungi, and the like. Fibers having a structure in which such cellulose is aggregated into the shape of a fiber and a fiber diameter of a microsize are referred to as cellulose microfibers, and fibers having a structure in which such cellulose is aggregated into the shape of a fiber and a fiber diameter of less than the microsize are referred to as cellulose nanofibers.

In natural, the cellulose nanofibers exist in a state of being rigidly aggregated by a mutual interaction such as a hydrogen bond between fibers, and hardly exist as a single fiber. In addition, for example, pulp that is used as a raw material of paper is obtained by defibrating wood, has a fiber diameter of a microsize of approximately 10 μm to 80 μm, and is in the shape of fibers in which cellulose nanofibers are rigidly aggregated by the mutual interaction described above such as a hydrogen bond. Such pulp is further defibrated, and thus, the cellulose nanofibers are obtained. Examples of a defibration method include a chemical treatment such as an acid hydrolysis method and a mechanical treatment such as a grinder method.

It is preferable that ϕF/D1 that is a ratio of an average fiber diameter ϕF of the fibers according to some embodiments to the central granule diameter D1 of the granule-shaped activated carbons be 0.0009 to 0.625. By setting the average fiber diameter ϕF of the fibers to be within the range described above, preferred granularity of the granular activated carbon is obtained. From such a viewpoint, it is more preferable that ϕF/D1 be 0.0294 to 0.2273. Furthermore, in some embodiments, the average fiber diameter ϕF of the fibers is calculated by measuring fiber diameters of arbitrary numbers of fibers at 30 spots with an electronic microscope such as a scanning electronic microscope, and by averaging the numerical values.

In addition, the fibers according to some embodiments are contained in the granular activated carbon by 1 volume % to 5 volume %. By setting the volume ratio of the fibers to be within the range described above, it is possible to make the granularity of the granular activated carbon and an adsorption efficiency of the granular activated carbon compatible. From such a viewpoint, it is more preferable that the volume ratio (%) described above be 1 volume % to 3 volume %.

The granular activated carbon of some embodiments is formed by binding the granule-shaped activated carbons described above, the nanofibers of the synthetic resin fibers as the fibers described above, and the like. A mechanism of forming a granulated body by binding the granule-shaped activated carbons, the synthetic resin nanofibers as the fibers, and the like is not obvious, but for example, the following reasons are considered. First, the fibers and the granule-shaped activated carbons are entangled with each other, and thus, a mechanical strength is exhibited. The granular activated carbon according to some embodiments is capable of forming the granulated body by a method for manufacturing the granular activated carbon described below, in a state where the fibers and the granule-shaped activated carbons are entangled with each other. In addition, the surface of the granule-shaped activated carbons is not completely hydrophobic, and several % of oxygen exists on the surface of the activated carbon in the form of a carboxy group or a hydroxy group. Similarly, a hydroxy group exists on the surface of the synthetic resin nanofibers or the like. For this reason, it is considered that a hydrogen bond occurs between the surface of the activated carbon and the synthetic resin nanofibers, and thus, the granulated body is rigidly formed. Furthermore, in embodiments of the present invention, the “binding” is a concept including mechanical binding according to the entanglement between the fibers described above and the granule-shaped activated carbons, and a chemical bond such as a hydrogen bond.

### Water Purification Cartridge

The water purification cartridge according to some embodiments is used in the water filter for purifying the water to be treated such as tap water, and contains the granular activated carbon described above. The water purification cartridge according to some embodiments is not particularly limited. The granular activated carbon contained in the water purification cartridge, for example, is dispersed in water to be slurry, and then, is subjected to suction molding, and is used as a molded body of an activated carbon. The molded body of the activated carbon may further contain fibril fibers or an ion-exchange material. In addition, the water purification cartridge according to some embodiments may include a ceramic filter or the like as a support member of the molded body of the activated carbon described above, a filtration filter such as a hollow fiber membrane, a non-woven fabric for protecting the surface of the molded body of the activated carbon described above, and the like.

### Method for Manufacturing Granular Activated Carbon

A method for manufacturing the granular activated carbon in some embodiments includes a stirring step, a granulating step, and a dewatering step. First, in the stirring step, the granule-shaped activated carbons having an arbitrary granule diameter that are pulverized and classified by a known method, the fibers such as the nanofibers, and water are mixed and stirred, and thus, a slurry-like raw material mixture is obtained.

Next, in the granulating step, the raw material mixture is granulated. The granulating step according to some embodiments includes a step for spraying and drying slurry that is obtained by dispersing the granule-shaped activated carbons and the fibers in water. Such a granular method is not particularly limited, and for example, the granulation can be performed by using a spray dryer method. In the spray dryer method, the raw material mixture is put into a spray dryer, and is subjected to spraying and drying, and thus, the granules of the raw material mixture are obtained. By suitably adjusting the parameters of the spray dryer such as a jet pressure, a nozzle diameter, a circulating air volume, and a temperature, it is possible to form granules having an arbitrary size. By using the spray dryer method described above, it is possible to form the granulated body in a state where the granule-shaped activated carbons and the fibers are entangled with each other (a dry state).

After that, in the dewatering step, the granules of the raw material mixture that are formed are placed in a heating furnace, and are subjected to dewatering. A heating temperature is not particularly limited, and for example, can be set to approximately 130° C. By performing the dewatering in the dewatering step, the granule-shaped activated carbons and the fibers become a rigid granulated body, and thus, a granulated body structure does not collapse even in a case where the granulated body is put into water. By the steps described above, it is possible to manufacture the granular activated carbon according to some embodiments.

The granular activated carbon according to some embodiments described above can be granulated without using a water-soluble binder or a heat-welding binder, and is excellent in a specific surface area or a fine pore volume that is a representative index of an activated carbon performance, compared to the granule-shaped activated carbons of the related art. It is preferable that the binder be composed only of net-like fibers from the viewpoint of water flow properties. On the other hand, the binder may contain not only the net-like fibers but also a water-soluble binder or a heat-welding binder such that the granulation is facilitated.

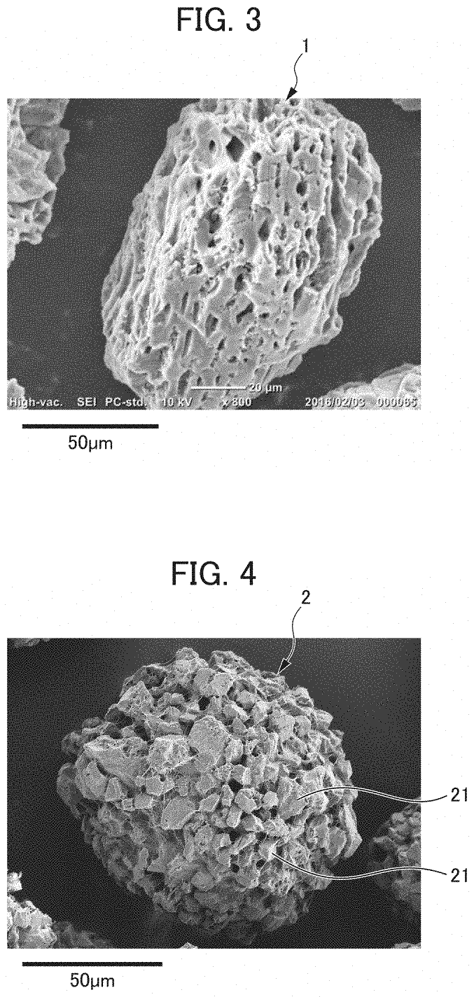

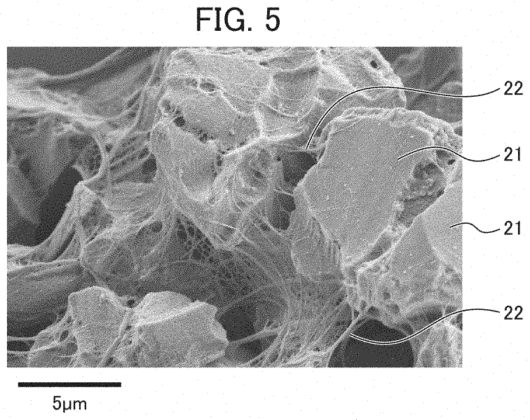

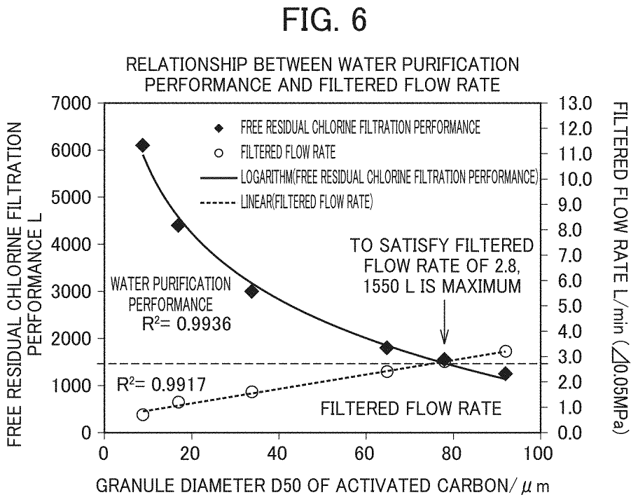

FIG. 3 and FIG. 4 are images that are obtained by similarly aligning granularity distributions of the granule-shaped activated carbons of the related art and the granular activated carbon according to some embodiments with a sieve of 63 μm/90 μm (170 meshes/230 meshes), and by respectively capturing images of the granule-shaped activated carbons of the related art and the granular activated carbon according to some embodiments with a scanning electronic microscope. FIG. 3 illustrates granule-shaped activated carbons 1 of the related art, and FIG. 4 illustrates a granular activated carbon 2 containing granule-shaped activated carbons 21 according to some embodiments. In addition, FIG. 5 is an image that is obtained by further enlarging the granular activated carbon 2 according to some embodiments, and by capturing an image of the granular activated carbon 2 according to some embodiments with a scanning electronic microscope. As obvious from FIG. 5, the granule-shaped activated carbons 21 and fibers 22 are entangled with each other, and thus, the granulated body is formed without using a water-soluble binder or a heat-welding binder.

In addition, as obvious from FIG. 3 and FIG. 4, the granular activated carbon 2 according to some embodiments is formed by granulating the granule-shaped activated carbons 21 having a small granule diameter, compared to the granule-shaped activated carbons 1 of the related art, and is excellent in a specific surface area.

In Table 1 described below, the granularity distributions described above are similarly aligned, and a specific surface area and a fine pore volume of the granule-shaped activated carbons 1 of the related art in FIG. 3 and the granular activated carbon 2 according to some embodiments in FIG. 4 were respectively measured, and the numerical values were compared to each other. The specific surface area in Table 1 was calculated by a BET method, the fine pore volume of the micropores was calculated by an MP method, and the fine pore volume of the mesopores and the macropores was calculated by a BJH method. Furthermore, a “t-plot method” is used as the MP method, and the MP method is a method for obtaining a distribution of a micropore volume or the like, and indicates a fine pore measurement method described in the literature (Colloid and Interface Science, 26, 46 (1968)). In addition, the BJH method is a calculation method that is used for analyzing the mesopores or the macropores, and is proposed by Barrett, Joyner, and Halenda.

TABLE 1

| | Specific | Fine pore volume | | | Total |
|---|---|---|---|---|---|
| | surface | (cm³/g) | | | fine pore |
| | area | (Micro- | (Meso- | (Macro- | volume |
| | (m²/g) | pores) | pores) | pores) | (cm³/g) |
| Granule-shaped | 1139 | 0.48 | 0.098 | 0.0075 | 0.49 |
| activated | | | | | |
| carbons 1 | | | | | |
| Granular | 1693 | 0.73 | 0.3 | 0.024 | 0.81 |
| activated | | | | | |
| carbon 2 | | | | | |

As obvious from Table 1, it is assumed that the granular activated carbon 2 according to some embodiments represents a high numerical value such as the specific surface area of approximately 1.5 times and the total fine pore volume of approximately 1.7 times, compared to the granule-shaped activated carbons 1 of the related art, and a preferred adsorption efficiency is obtained.

Furthermore, in some embodiments, a method for determining whether or not the granulated body is formed is not particularly limited, and for example, the presence or absence of the granulated body can be determined by observing the granulated body with an electronic microscope or the like.

In some embodiments, a central granule diameter D2 of the granular activated carbon is not particularly limited, and is preferably 60 μm to 100 μm. First, the central granule diameter D2 is greater than 40 μm, and thus, it is difficult to densify the granular activated carbon, and to increase water flow resistance. In addition, the central granule diameter D2 is set to be 2 mm or less, and thus, it is possible to further decrease a gap between the granular activated carbons, and to increase an adsorbed amount per total volume of the activated carbon. Further, in a case where the central granule diameter D2 is less than 60 μm, it is difficult to maintain a filtered flow rate that a user does not feel inconvenience (hereinafter, also simply referred to as a predetermined flow rate). In addition, in a case where the central granule diameter D2 is greater than 100 μm, it is difficult to increase the water purification performance. As described above, it is preferable that the central granule diameter D2 of the granular activated carbon be 60 μm to 100 μm. Furthermore, as with the central granule diameter D1, the central granule diameter D2 is a value that is measured by a laser diffraction method, and indicates a value (D50) of 50% diameter in volume-based cumulative fractions.

As described above, the granular activated carbon according to some embodiments, contains: the plurality of granule-shaped activated carbons; and the binder for binding the plurality of granule-shaped activated carbons, in which the binder is composed of the net-like fibers. Accordingly, it is possible to provide a granular activated carbon having a filtered flow rate of a predetermined value or more and a high water purification performance.

In addition, the fibers are bound by being entangled with the granule-shaped activated carbons on the surface of the granular activated carbon and inside the granular activated carbon. Accordingly, the water flow properties of the granular activated carbon are improved.

In addition, the fibers are contained in the granular activated carbon by 1 volume % to 5 volume %. In addition, such fibers include at least fibril fibers or nanofibers.

In addition, the central granule diameter D1 of the granule-shaped activated carbons is 40 μm or less. Accordingly, the adsorbed amount of the removal target per unit mass of the granular activated carbon containing the granule-shaped activated carbons is improved. In addition, the specific surface area of the granular activated carbon containing the granule-shaped activated carbons increases.

In addition, the method for manufacturing the granular activated carbon according to some embodiments, includes: the step for spraying and drying the slurry that is obtained by dispersing the granule-shaped activated carbons and the fibers in water. By such a method for manufacturing, the binder can be composed of the net-like fibers, and a method for manufacturing a granular activated carbon having a filtered flow rate of a predetermined value or more and a high water purification performance can be provided.

Furthermore, embodiments of the present invention are not limited to the embodiments described above, and modifications and enhancements are included in the present invention within a range in which an object of the present invention can be attained. The cellulose, synthetic resin nanofibers, or the like has been described as an example of the fibers of the present invention, but the fibers are not limited to the cellulose, synthetic resin nanofibers, or the like insofar as the fibers are a fiber-like substance that is capable of forming the granulated body. In addition, a target to be granulated by the binder is not limited to the granule-shaped activated carbons. For example, an additive other than the granule-shaped activated carbons may be added for a lead removal or antibacterial purpose. Specifically, the granulation may be performed by mixing the granule-shaped activated carbons with zeolite that is an ion exchanger.

### EXAMPLES

Hereinafter, embodiments of the present invention will be described in more detail, on the basis of examples.

### Examples 1 to 7, Comparative Examples 1 to 2

Granule-shaped activated carbons having a granule diameter D50 of 9 μm were granulated by a spray dryer method at a compounded amount of the fibers shown in Table 2, and thus, activated carbons of Examples 1 to 7 and Comparative Examples 1 and 2 were obtained. A TAIKO activated carbon CN8200S (manufactured by Futamura Chemical Co., Ltd.) with a jet mill EJMOQ (manufactured by EARTHTECHNICA Co., LTD.) was pulverized to prepare the granule-shaped activated carbons having a granule diameter D50 of 9 μm, and nanofibers that were obtained by refining a fibrillate synthetic resin with wet pulverization were used as the fibers. In addition, the condition of the spray dryer method was as follows.

### Spray Dryer Method

Slurry that was obtained by dispersing the granule-shaped activated carbons and the fibers in water was prepared, and was subjected to spraying and drying at a drying temperature of 230° C. by a disk type spray dryer FOC-20 (manufactured by OHKAWARA KAKOHKI CO., LTD.).

A granular strength of the activated carbons of Examples 1 to 7 and Comparative Examples 1 and 2 was evaluated on the basis of the following standards. The results are shown in Table 2.

### Granular Strength

2: Even in the case of performing a water flow test in the following condition, the granule-shaped activated carbons did not collapse (were capable of being granulated).

1: In the case of performing the water flow test in the following condition, the granule-shaped activated carbons collapsed (were not capable of being granulated).

0: The granule-shaped activated carbons were not bound together (were not capable of being granulated).

Subsequently, a granulation diameter of Examples 1 to 7 (the granule diameter D50 after granulation) was measured by microtrac MT3300EXII (a laser diffraction and scattering type granule diameter distribution meter, manufactured by MicrotracBEL Corp.), a maximum fiber diameter was observed by a scanning electronic microscope (S-3400N, manufactured by Hitachi High-Technologies Corporation), and a fiber diameter was measured by image processing. The results are shown in Table 2.

### Comparative Examples 3 to 8

An activated carbon having a granule diameter shown in Table 2 was set to activated carbons of Comparative Examples 3 to 8. Specifically, the activated carbons of Comparative Examples 3 to 8 were prepared by pulverizing a TAIKO activated carbon CN8200S (manufactured by Futamura Chemical Co., Ltd.) with a jet mill EJMOQ (manufactured by EARTHTECHNICA Co., LTD.) or a dry ball mill.

### Water Flow Test

The activated carbons of Examples 1 to 7 and Comparative Examples 3 to 8 were subjected to molding processing into the shape of a cylinder having an outer diameter of 24.7 mm, an inner diameter of 8 mm, and a height of 90 mm, and were subjected to a free residual chlorine filtration performance test based on JIS 53201. The results are shown in Table 2.

In addition, a filtered flow rate at the time of performing a water flow at 40.05 MPa was measured in the same shape. The results are shown in Table 2.

TABLE 2

| | Compounded | Granule diameter | | | Granulation | Maximum | Water | Filtered |
|---|---|---|---|---|---|---|---|---|
| | amount of | of activated | Granular | Granulation | diameter | fiber diameter | purification | flow rate |
| | fibers (vol %) | carbon D50(μm) | strength | availability | D50(μm) | ϕ(μm) | performance (L) | (L/min) |
| Comparative | 0.1 | 9 | 0 | Granulation | — | — | — | — |
| Example 1 | | | | unavailable | | | | |
| Comparative | 0.5 | 9 | 1 | Granulation | 70 | 0.5 | — | — |
| Example 2 | | | | unavailable | | | | |
| Example 1 | 1 | 9 | 2 | Granulation | 73 | 0.4 | 2550 | 2.8 |
| | | | | available | | | | |
| Example 2 | 2 | 9 | 2 | Granulation | 72 | 0.5 | 2200 | 2.8 |
| | | | | available | | | | |
| Example 3 | 3 | 9 | 2 | Granulation | 72 | 0.3 | 1850 | 2.8 |
| | | | | available | | | | |
| Example 4 | 4 | 9 | 2 | Granulation | 73 | 0.4 | 1750 | 2.8 |
| | | | | available | | | | |
| Example 5 | 5 | 9 | 2 | Granulation | 74 | 0.5 | 1650 | 2.8 |
| | | | | available | | | | |
| Example 6 | 6 | 9 | 2 | Granulation | 74 | 0.4 | 1300 | 2.8 |
| | | | | available | | | | |
| Example 7 | 10 | 9 | 2 | Granulation | 72 | 0.5 | 800 | 2.8 |
| | | | | available | | | | |
| Comparative | 0 | 9 | — | — | — | — | 6100 | 0.7 |
| Example 3 | | | | | | | | |
| Comparative | 0 | 17 | — | — | — | — | 4400 | 1.2 |
| Example 4 | | | | | | | | |
| Comparative | 0 | 34 | — | — | — | — | 3000 | 1.6 |
| Example 5 | | | | | | | | |
| Comparative | 0 | 65 | — | — | — | — | 1800 | 2.4 |
| Example 6 | | | | | | | | |
| Comparative | 0 | 78 | — | — | — | — | 1550 | 2.8 |
| Example 7 | | | | | | | | |
| Comparative | 0 | 92 | — | — | — | — | 1250 | 3.2 |
| Example 8 | | | | | | | | |

From the comparison between Examples 1 to 7 and Comparative Examples 3 to 8, it was observed that the granular activated carbon, contained: the plurality of granule-shaped activated carbons; and the binder for binding the plurality of granule-shaped activated carbons, in which the binder was composed of the net-like fibers, and thus, a granular activated carbon having a filtered flow rate of a predetermined value or more and a high water purification performance was obtained.

From the comparison between Examples 1 to 5 and Comparative Example 7, it was observed that in the granular activated carbons of Examples 1 to 5, the filtered flow rate was 2.5 L/min or more, and the water purification performance was higher than that of Comparative Example 9. That is, it was observed that the amount of fibers with respect to the granular activated carbon was set to 1 volume % to 5 volume %, and thus, a granular activated carbon having a filtered flow rate of a predetermined value or more and a water purification performance of greater than 1550 L was obtained.

From the comparison between Examples 1 to 3 and Comparative Example 8, it was observed that even though the filtered flow rate was 2.5 L/min or more, in the granular activated carbons of Examples 1 to 3, the water purification performance was higher than that of Comparative Example 8 in which the filtered flow rate was 2.4 L/min. That is, it was observed that the amount of fibers with respect to the granular activated carbon was set to 1 volume % to 3 volume %, and thus, a granular activated carbon having a filtered flow rate of a predetermined value or more and a water purification performance of greater than 1800 L was obtained.

1. A granular activated carbon, comprising:
a plurality of granule-shaped activated carbons; and
a binder for binding the plurality of granule-shaped activated carbons,
wherein the binder is composed of net-like fibers.

2. The granular activated carbon of claim 1,
wherein the fibers are bound by being entangled with the granule-shaped activated carbons on a surface of the granular activated carbon and inside the granular activated carbon.

3. The granular activated carbon of claim 1, wherein the fibers are contained in the granular activated carbon by 1 volume % to 5 volume %.

4. The granular activated carbon of claim 1, wherein the fibers are fibril fibers.

5. The granular activated carbon of claim 1, wherein the fibers are nanofibers.

6. The granular activated carbon of claim 1, wherein a central granule diameter of the granule-shaped activated carbons is 40 μm or less.

7. The method for manufacturing the granular activated carbon of claim 1, the method comprising a step for spraying and drying slurry which is obtained by dispersing the granule-shaped activated carbons and the fibers in water.
